(19) United States
(12) Patent Application Publication
(10) Pub. No.: US 2021/0351734 A1
(43) Pub. Date: Nov. 11, 2021

(54) DEVICE FOR CONTROLLING AN INVERTER

(71) Applicant: IFP Energies nouvelles, Rueil-Malmaison (FR)

(72) Inventors: Alexandre BATTISTON, RUEIL-MALMAISON (FR); Emmanuel KUENTZMANN, RUEIL-MALMAISON (FR); Fabien VIDAL-NAQUET, RUEIL-MALMAISON (FR); Wissam DIB, RUEIL-MALMAISON (FR); Najla HAJE OBEID, RUEIL-MALMAISON (FR)

(21) Appl. No.: 17/282,620

(22) PCT Filed: Sep. 17, 2019
(86) PCT No.: PCT/EP2019/074809

§ 371 Date: Apr. 2, 2021

(30) Foreign Application Priority Data
Oct. 3, 2018 (FR) 1859187

(51) Int. Cl. H02P 27/06

(52) U.S. Cl. CPC H02P 27/06

(57) ABSTRACT

In an inverter system (1) associated with an electric machine (2), a control device (9) involves a pulse width modulation technique with a variable frequency in order to optimize the efficiency of the system.

According to the invention, the current switching frequency values are limited according to other criteria, among which noise or the torque deformations of machine (2) or the electrical loads imposed on a capacitor (8) of the filter stage (4).

### FIELD OF THE INVENTION

The invention relates to an inverter control device arranged between a power supply and an electric machine for converting the generally direct current delivered by the power supply to an alternating current usable by the machine.

### BACKGROUND OF THE INVENTION

Inverters comprise switches respectively associated with the phase wires of the electric machine, whose commutations between open and closed are synchronized so as to convert the direct current to an approximately sinusoidal current with the desired phase shift for each phase. In these methods, known as pulse width modulation (PWM), an important parameter to be considered is the frequency of the current switching pulses. Ideally, to obtain a regular torque for the electric machine and to maximize the efficiency thereof, the current of each phase needs to be as regular sinusoidal as possible, which is obtained by increasing the switching frequency of the inverter. However, the switching frequency increase also comes very significantly at the expense of the inverter efficiency. An optimal switching frequency (often defined as the overall efficiency of the system comprising the inverter and the electric machine) is therefore generally sought so as to best reconcile these contradictory requirements. This optimal frequency however varies according to the operating parameters of the electric machine, notably the rotational speed co and the load thereof, which can be correlated with the intensity I of the power supply current. Methods allowing the switching frequency of the inverter to be adjusted according to one or another operating parameter have already been proposed. Document U.S. Pat. No. 8,456,115 B2, which proposes control of an electric motor with a variable switching frequency selected according to the engine operating point over two speed ranges, and document U.S. Pat. No. 9,024,557 B2, which proposes control of an inverter with a variable switching frequency over the entire engine speed or load range, can be mentioned.

The invention is based on the finding that such methods are however inadequate to guarantee proper operation of the system under all circumstances. An improved control device is therefore proposed for the inverter.

### SUMMARY OF THE INVENTION

In one general aspect, the invention relates to a control device for an inverter belonging to a system notably comprising an electric machine and a power supply delivering an electric current to the electric machine through the inverter, the control device being so designed as to cause the inverter to apply an electric current switching frequency that varies according to operating parameters of the electric machine in order to ensure optimal operation, characterized in that it comprises a map providing for each parameter value at least one allowable extreme frequency according to at least one other parameter, which is a parameter of proper operation of an element of the system.

The invention is thus based on the recognition of parameters other than the operating parameters of the machine for selection of the switching frequency, possibly by giving up the frequency that would ensure optimal system efficiency, if it is found that it might lead to a malfunction state likely to damage or degrade it in any way.

The map can be generated beforehand and used on each system restart or, on the contrary, online, i.e. during operation of the system, on each start-up thereof.

The operating parameters of the electric machine used in connection with the method perfected by the invention can be the conventional machine rotational speed and power supply current intensity parameters.

The map may have been generated using any suitable technique, notably numerical analyses or simulations, notably computer-assisted.

The allowable extreme frequency can depend on a plurality of parameters consistent with the above, each of which becomes preponderant for a respective part of the possible operating parameter values. The extreme frequency function can then be considered as a synthesis or a concatenation of the functions of each of the other parameters considered.

In many cases, the extreme frequency is a minimum frequency. This is notably often the case with systems commonly comprising a capacitor-input filter between the power supply and the inverter. The proper operation parameter can then be an effective current intensity reaching the capacitor or a voltage variation rate at the terminals thereof. In other possible embodiments of the invention, the parameter can be a noise emitted by the electric machine, a torque deformation (irregularity) of the electric machine, a total harmonic distortion of the current circulating in the electric machine, or an absolute amplitude of this distortion.

### BRIEF DESCRIPTION OF THE FIGURES

Other features and advantages of the invention will be clear from reading the description hereafter of an embodiment given by way of non-limitative example, with reference to the accompanying figures wherein:

FIG. 1 shows the system comprising the inverter,

FIGS. 2a and 2b show methods of switching direct current at different frequencies,

FIG. 3 illustrates loss curves in the inverter,

FIG. 4 shows the inverter control device, and

FIG. 5 illustrates curves where a frequency limit point is obtained.

### DETAILED DESCRIPTION OF THE INVENTION

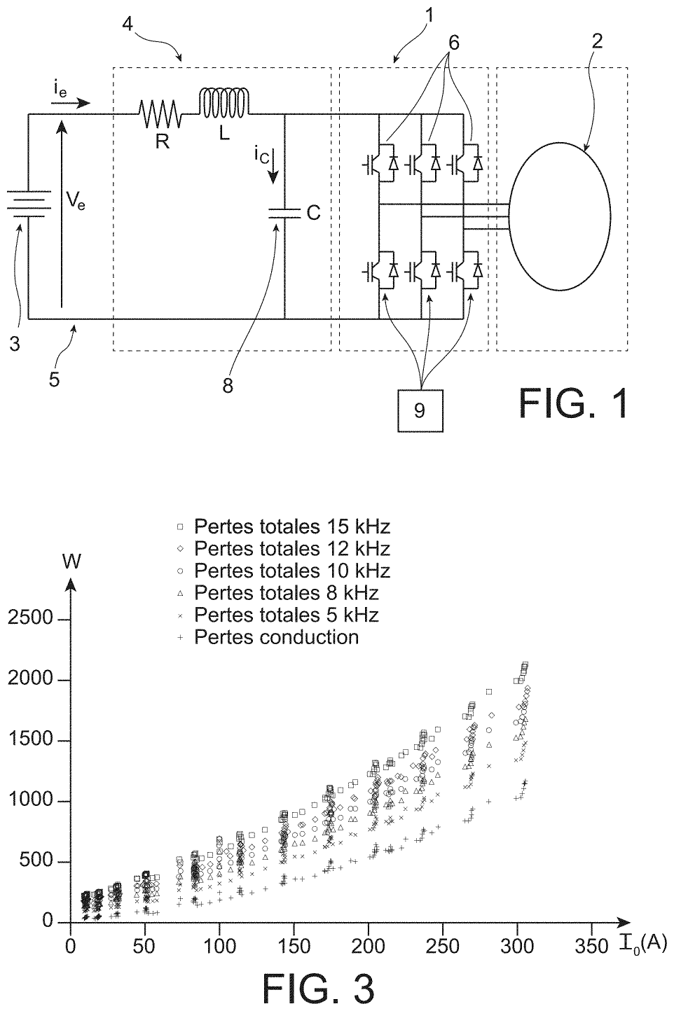

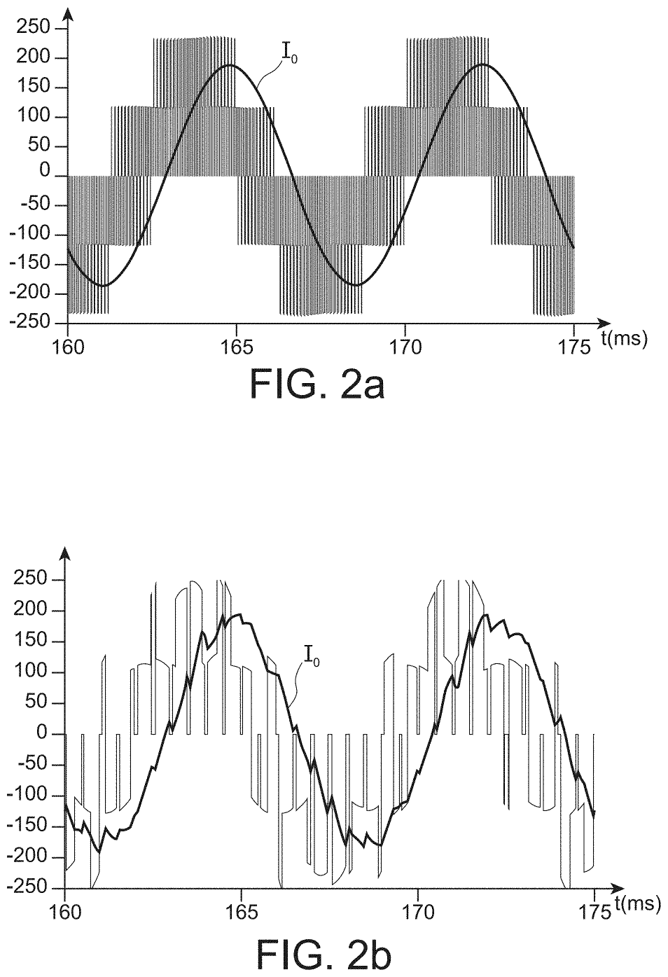

FIG. 1 is a conventional diagram showing a three-phase inverter system 1 associated with an electric machine 2. A voltage source Vₑ (a battery for example) is a power supply 3 delivering a direct power supply current iₑ. A filtering stage 4 allows to limit the perturbations generated by inverter 1 and to stabilize bus 5 carrying power supply current iₑ. Switches 6 of inverter 1, controlled in a complementary manner, allow variable voltage slots to be applied to electric machine 2, as illustrated in FIGS. 2a and 2b. In FIG. 2a, the switching frequency f of power supply current iₑ by inverter 1 is significantly higher than in FIG. 2b. It is noted that the harmonic content (deformations) of the sinusoidal current of phase a Iₐ supplied to electric machine 2 is much lower. However, the increase in switching frequency f comes at the expense of the efficiency of inverter 1: losses occur in fact upon each commutation of switches 6. FIG. 3 illustrates the losses of inverter 1 according to the amplitude I₀ of the phase current in the electric machine and switching frequency f. Conduction losses represent the irreducible part of the losses of inverter 1. The efficiency of inverter 1 thus decreases with the increase in switching frequency f in a very significant manner. A trade-off therefore needs to be made between the increase in switching frequency f to limit the occurrence of deleterious phenomena such as the ageing of power supply 3, the excessive stress on filtering stage 4 and the operational stability of the system, and the decrease thereof to increase the efficiency of inverter 1. A known partial answer lies in the continuous adaptation of switching frequency f during operation: a switching frequency f is made variable, for example according to the speed of electric machine 2 or amplitude I₀ of the phase current, as mentioned.

Ideally, determining switching frequency f can be done for example via minimization of an arbitrary cost. Typically, it is the overall efficiency of the system (other cost parameters can be selected without departing from the scope of the invention).

We then seek, for a given speed ω and a given current I:

f(ω,I) such that η(ω,I)=max(η(f,ω,I))

where η is the efficiency of the system comprising inverter 1 and electric machine 2.

The compromise considered is that the increase in switching frequency f improves the efficiency of electric machine 2, whereas the decrease thereof improves the efficiency of inverter 1.

Conventional methods do however not guarantee satisfactory operation of the system of FIG. 1, as described so far. High efficiency of electric machine 2 can be accompanied by inadmissible torque deformations (irregularities) or loud noise produced by electric machine 2, which may indicate damage. Sudden current variations through filtering stage 4 may also cause damage, especially a capacitor 8 used to absorb the oscillations of high-frequency current draws and relieve power supply 3, because capacitor 8 can damage itself if it is not dimensioned to ensure sufficient capacity. Other system malfunction criteria, leading to possible damage or not, may be considered.

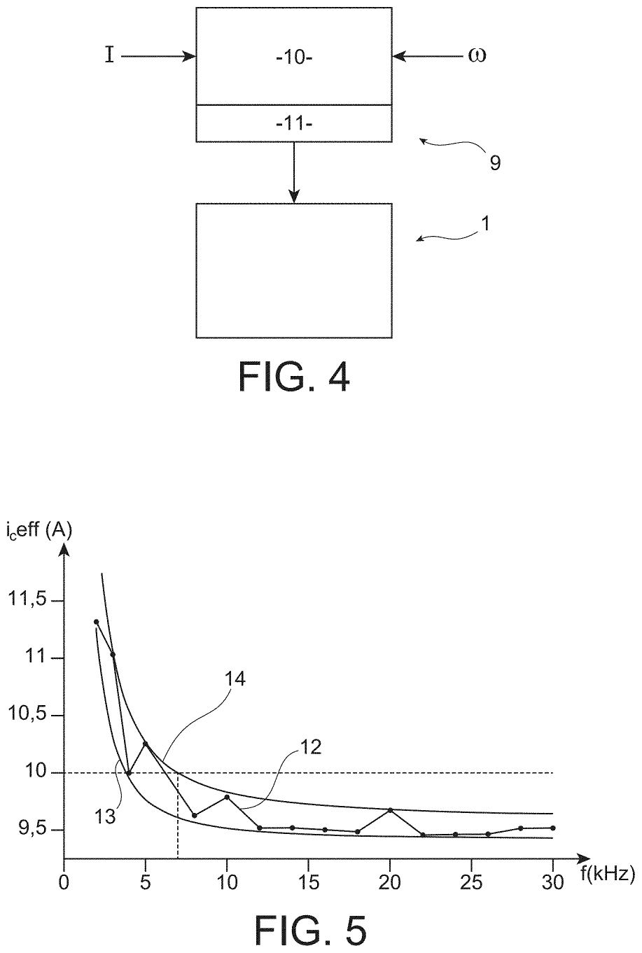

The inverter is provided with a control device 9 for switches 6 that are detailed hereafter in connection with FIG. 4.

It comprises a main stage 10 providing application of the optimal efficiency search method, or any other method of selecting switching frequency f consistent with the above, according for example to the intensity I of power supply current Ie and to rotational speed ω of electric machine 2, provided thereto by any sensor. It also comprises, as is characteristic of the invention, a downstream stage 11 that might be referred to as digital filtering stage, which checks that the switching frequency f proposed by main stage 10 meets one or more criteria for proper operation of the system.

Downstream stage 11 indicates at least a limit value for switching frequency f, according to predetermined specifications, for any value of the operating parameters (I, ω, etc.) exploited by main stage 10. The idea is to translate the constraints for proper operation of the system into allowable (most often minimum) limit values for switching frequency f.

For example, selection of a maximum noise level for the electric machine, in dB, can be expressed as a constraint on the minimum switching frequency f. Indeed, as seen above, the harmonic content of the currents in electric machine 2 has an impact on the torque and therefore on the noise. Similarly, a maximum torque deformation criterion can also be expressed as a minimum switching frequency limit.

Moreover, filtering stage 4 at the inlet of inverter 1 is directly affected by switching frequency f because input capacitor 8 smoothes the current draws. Two limits apply to this capacitor 8:
the dissipated energy (function of i_{c}^{eff})², which is the amplitude of effective current at the terminals thereof), and which can lead to the destruction thereof if it is too high,
the dV/dt (voltage variation rate) undergone by capacitor 8, which can also lead to the destruction thereof.

These two operating limits can also translate into minimum switching frequencies, which also depend on the operating point of the electric motor.

In summary, the constraints on the minimum switching frequency can be, possibly in descending order of importance:
the dV/dt rate undergone by capacitor 8,
the energy dissipated by capacitor 8,
the maximum noise level of electric machine 2,
the maximum torque deformation criterion for electric machine 2,
the total harmonic distortion of the current circulating in electric machine 2,
the absolute amplitude of harmonic distortion of the current circulating in electric machine 2.

Preparation of downstream stage 11 of control device 9 can be done as follows:

1. Determining at least one proper operation constraint depending on switching frequency f, for example according to specifications relative to electric machine 2 and/or inverter 1 and/or filtering stage 4,

2. translating this constraint into an extreme switching frequency f for a set of operating points of the electric machine (defined by current I in the phases and by rotational speed ω of the electric machine); this set of points forms a map of the extreme switching frequency f as a function of I and ω. This step can be carried out analytically or by numerical simulations for various switching frequencies f,

3. storing this map in control system 9 of inverter 1.

Inverter 1 is then controlled in the usual manner, but with a variable limitation of switching frequency f, governed by the numerical map expressing an extreme frequency value for each value of parameters I or ω, taken into account in the main method. The switching frequency f before possible limitation can be obtained in main stage 10 by any method known to the person skilled in the art. Explicit calculation of the switching frequency f to be applied can then consist in solving:

$$f ( ω , I ) such that \{ \begin{matrix}η ( ω , l ) = max ( η ( f , ω , l ) ) \\ f ( ω , l ) \geq f min ( ω , l )\end{matrix}$$

if all the limits have minimal frequencies; a third line is added as follows: f(ω, I)≤f max(ω, I) if a maximum frequency f max exists.

This explicit calculation of the switching frequency f to be applied is thus carried out while the system is operating, whereas the other steps relative to the generation of the map have been carried out beforehand, in a system calibration phase. This calibration can be definitive, i.e. it is not necessarily repeated upon each restart of the system since it concludes by loading the map into a memory. It is however specific to the system and it may need to be redone if electric machine 2 or filtering stage 4 are changed for example. The map can be constructed by means of analytic methods or simulations, among others. In other embodiments, calibration could on the contrary be performed during service, after each system start, using analytic methods for example.

An example is given in FIG. 5. This example relates to the criterion of the energy dissipated by capacitor 8. According to the capacity of capacitor 8, a threshold i_{c}^{eff} is defined for the current circulating in capacitor 8. The y-axis is the effective current value i_{c}^{eff} and the x-axis is switching frequency f. In the example, the allowable intensity threshold is 10 A.

Electric machine 2 and inverter 1 are simulated. For each simulation, switching frequency f is varied and current i_{c}^{eff} circulating through the capacitor is simulated.

The simulated value points can be bounded by envelopes 12 and 13. The extreme switching frequency selected is at the intersection of the allowable intensity threshold and the simulation curve (upper envelope 13 is preferably selected here). The minimum switching frequency fmin is therefore, according to the selected threshold value of 10 A, approximately 7 kHz for the corresponding value of parameters I and ω. The procedure simply needs to be reproduced for other (I, ω) pairs in order to obtain this limit fmin(ω, I) according to this criterion relative to the energy dissipated in capacitor 8 for all the operating points.

The extreme switching frequency can be, as the case may be, a minimum frequency or a maximum frequency. Methods comprising both a minimum frequency and a maximum frequency are possible. If there are several minimum (or maximum) frequency determination criteria, the limit allowing all the criteria to be satisfied is selected, for each value of operating parameters I and ω, i.e. the highest limit frequency in the case of the minimum frequency. The map then is a concatenation of the limit values for each selected criterion.

1. A control device for an inverter belonging to a system notably comprising an electric machine and a power supply delivering electric current to electric machine through the inverter, control device being so designed as to cause the inverter to apply an electric current switching frequency (f) that varies according to operating parameters (I, ω) of electric machine in order to ensure optimal operation, characterized in that it comprises a map providing for each parameter value (fmin, fmax) at least one allowable extreme frequency according to at least one other parameter, which is a parameter of proper operation of an element of the system.

2. An inverter control device as claimed in claim 1,
wherein the map is obtained beforehand.

3. An inverter control device as claimed in claim 1,
wherein the map is obtained during operation, upon start-up of the system.

4. An inverter control device as claimed in claim 1, wherein the operating parameters of the electric machine are a rotational speed (ω) of electric machine and a current intensity (I).

5. An inverter control device as claimed in claim 1, wherein the map was generated using numerical analyses and/or simulations.

6. An inverter control device as claimed in claim 1, wherein the allowable extreme frequency depends on a plurality of the other parameters, which are each preponderant for a respective part of possible operating parameter values.

7. An inverter control device as claimed in claim 1, wherein the allowable extreme frequency is a minimum frequency (fmin).

8. An inverter control device as claimed in claim 1, wherein the system comprises a capacitor input filter between power supply and inverter.

9. An inverter control device as claimed in claim 7, wherein the other parameter is an effective intensity (i_{c}^{eff}) of the current circulating in capacitor.

10. An inverter control device as claimed in claim 7, wherein the other parameter is a voltage variation rate
$$( \frac{dV}{dt} )$$
at the terminals of capacitor.

11. An inverter control device as claimed in claim 7,
wherein the other parameter is a noise emitted by electric machine.

12. An inverter control device as claimed in claim 7,
wherein the other parameter is a torque deformation of electric machine.

13. An inverter control device as claimed in claim 7,
wherein the other parameter is a total harmonic distortion of the current circulating in electric machine.

14. An inverter control device as claimed in claim 7,
wherein the other parameter is an absolute amplitude of harmonic distortion of the current circulating in electric machine.
